(19) United States
(12) Patent Application Publication
(10) Pub. No.: US 2014/0174479 A1
(43) Pub. Date: Jun. 26, 2014

(54) PARTS WASHER ASSEMBLY WITH CLEAN RINSE MODULE

(71) Applicant: Rudy Publ, Glendale Heights, IL (US)

(72) Inventor: Rudy Publ, Glendale Heights, IL (US)

(21) Appl. No.: 13/722,688

(22) Filed: Dec. 20, 2012

(51) Int. Cl. B08B 3/04

(52) U.S. Cl. CPC B08B 3/04
USPC 134/26; 134/94.1

(57) ABSTRACT

A parts washer assembly including a reservoir that may have a contaminated fluid solution at a level and a cover with an opening formed therein on an open end of the reservoir. A clean rinse module including a flange, a tank, a first pump and a second pump that may be disposed in the reservoir contiguous with the cover so that the tank and the first and second pumps depend from the flange into the reservoir. The tank may include an opening above the level of the contaminated fluid solution. The first pump may be connected to the flange and in fluid communication with the tank.

### FIELD OF DISCLOSURE

The present disclosure relates to a parts washer assembly having a removable clean rinse module.

### BACKGROUND

During maintenance, repair and rebuilding operations in virtually all industrial and commercial environments, it is necessary to wash a wide variety of parts and articles in order to remove grease, oil, dirt and other contaminants. Typically, volatile fluids are used in almost all small parts cleaning operation as they have been found to be most effective in removing grease and other accumulated residue from metal parts and other articles. A well-known and widely used means for washing automotive, aviation, marine, industrial and general parts, components and tools during service, maintenance, repair, rebuilding operations etc. involves using a sink-on-a-drum apparatus in which a sink basin is placed on top of and installed to a drum containing a cleaning solution (e.g. a 16 or 30 gallon drum). A pump is provided which pumps the solution from the drum to a spigot in the sink basin, where the solution is used to rinse and clean parts. The solution then leaves the sink basin and returns to the drum (along with any contaminants removed from the parts).

Typically, the cleaning solution is stored in a single reservoir, such as a steel drum. Parts are typically washed using a cleaning solution that is initially clean and becomes contaminated over time, until the contaminated cleaning solution can no longer effectively clean the parts. The contaminated solution is continuously used (and therefore becomes more and more contaminated) during cleaning operations until it is eventually replaced with a clean drum of cleaning solution (e.g. based on the soil loading, application, etc.). The method for replacing the drum involves manually lifting the sink basin off of the drum, replacing the drum with a new drum, and then reinstalling the sink basin on the new drum of clean cleaning solution. The contaminated drum of cleaning solution must then be taken away and disposed of, or recycled, in a manner complying with EPA contaminant disposal guidelines.

A two reservoir configuration, where clean solvent and contaminated solvent are stored in separate reservoirs, may be used to extend the length of time between replacing cleaning solution. In the two reservoir configuration, the contaminated fluid is provided from the reservoir, such as a steel drum, and the clean fluid is provided from a separate reservoir from the contaminated fluid container. Because the clean and contaminated fluids are stored in separate containers, the length of time between replacement of cleaning solution is extended. However, because two reservoirs are used, additional maintenance is required to monitor the levels in the different containers to ensure consistent operation of the system. For example, a low level in the clean fluid container would prevent a user from rinsing a washed part. In addition, as the contaminated fluid is continuously reused, the level of contamination increases reducing the cleaning effectiveness of the contaminated fluid. Accordingly, a parts washer system is needed that combines a contaminated container and clean fluid container in a single system to reduce maintenance and improve cleaning efficiency, as well as, a system that dilutes the contaminated fluid with clean fluid to prolong the life of the contaminated fluid.

### SUMMARY OF THE DISCLOSURE

In one example, a parts washer assembly may include a reservoir having a contaminated fluid solution at a level and a cover, including an opening, surmounted on an open end of the reservoir. The assembly may also include a clean rinse module having a flange, a tank, a first pump and a second pump. The flange of the clean rinse module may be contiguous with the cover such that the flange covers the opening and the tank. An overflow opening may be formed in the tank above the level of the contaminated fluid to allow clean fluid to flow from the tank to the reservoir. The first pump is preferably connected to the flange, and is in fluid communication with the tank and a first fitting connected to the flange. The second pump is preferably connected to the flange, and is in fluid communication with the reservoir and a second fitting connected to the flange.

In another example, a collar may be surmounted on the open end of the reservoir and the cover is contiguous with an opening in the collar.

In another example, the first pump may be secured inside the tank by a conduit connected the flange.

In another example, the second pump may be secured inside the reservoir by a conduit connected the flange.

In yet another example, the first pump may be in fluid communication with a cleaning basin by a first tube coupled to the first fitting on the flange, and to the tank by a second tube.

In another example, the clean rinse module may be removably affixed to the cover.

In another example, the flange may include at least one handle on a top surface of the flange.

In another example, the collar may include at least one handle on a top surface of the collar.

In another example, the tank may include a drain on a lower portion of the tank.

In another example, a method of providing fluid to a cleaning basin is provided that includes the steps of storing a contaminated fluid solution at a level in a reservoir, storing a clean fluid in a tank of a clean rinse module in the reservoir, transferring the clean fluid from the tank to the reservoir by an overflow opening formed in the tank above the level of the contaminated fluid solution, providing the clean fluid to the cleaning basin by a first pump, providing contaminated fluid to the cleaning basin from the reservoir by a second pump, receiving contaminated fluid from the cleaning basin by a drain on the cleaning basin, and receiving the clean fluid from a recycling unit in fluid communication with the tank by a conduit connected to a fourth fitting on the flange.

### BRIEF DESCRIPTION OF THE DRAWINGS

The following disclosure as a whole may be best understood by reference to the provided detailed description when read in conjunction with the accompanying drawings, drawing description, abstract, background, and associated headings. Identical reference numerals when found on different figures identify the same elements or a functionally equivalent element.

FIG. 1A illustrates a first preferred embodiment of the parts washer system of the present disclosure,

FIG. 1B illustrates an expanded view of the parts washer system of FIG. 1A,

FIG. 2 illustrates a top view of the cover that surmounts on an open end of the reservoir in the parts washer assembly of FIG. 1B,

FIG. 3 illustrates a top view of a flange covering the tank of the clean rinse module in the parts washer assembly of FIG. 1B,

FIG. 4A illustrates a side view of a clean rinse module in the parts washer assembly of FIG. 1B,

FIG. 4B illustrates a side view of an alternate embodiment of the clean rinse module of FIG. 4A,

FIG. 5 illustrates a collar configured to surmount to the open end of the reservoir in the parts washer assembly of FIG. 1A,

FIG. 6 illustrates a schematic representation of a process of operating the parts washer assembly of FIG. 1A, and

FIG. 7 illustrates a schematic representation of a maintenance process for the parts washer assembly of FIG. 1A

### DETAILED DESCRIPTION

The present disclosure is not limited to the particular details of the apparatus or method depicted, and other modifications and applications may be contemplated. Further changes may be made in the above-described method and device without departing from the true spirit of the scope of the disclosure herein involved. It is intended, therefore, that the subject matter in the above depiction should be interpreted as illustrative, not in a limiting sense.

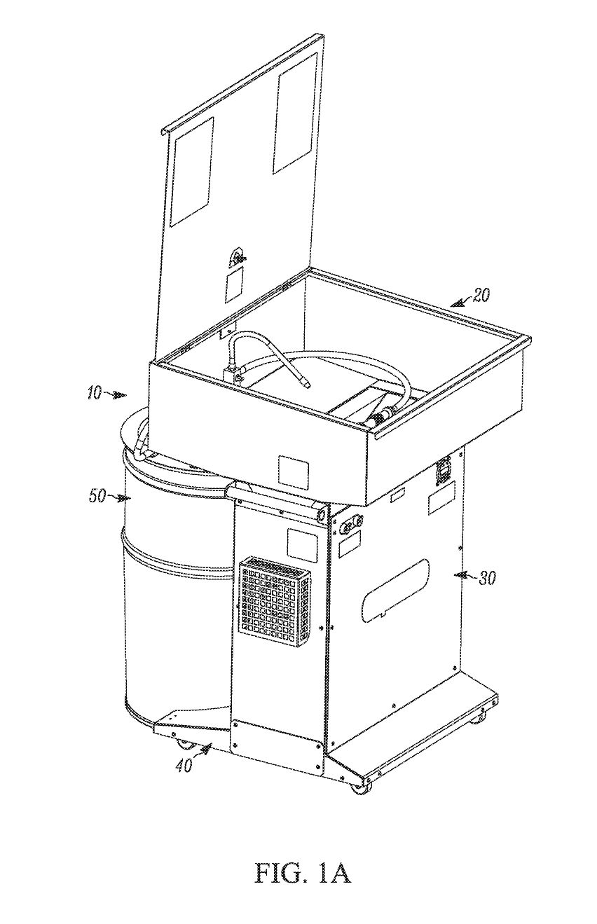

Turning to the drawings, FIG. 1A illustrates a first preferred embodiment of the parts washer system of the present disclosure 10, shown in an exploded view. The principal components of the present disclosure 10 are a cleaning basin 20, a core recycler component 30, and a docking base 40. These principal components integrate with a fluid reservoir 50 (e.g. a fluid-containing drum) that stores both clean and contaminated cleaning fluid.

The cleaning fluid is used to degrease or otherwise clean objects such as automotive parts, and typically has a boiling point lower than that of the contaminants that may become mixed with the cleaning solution during the cleaning of parts. The cleaning fluid, or cleaning solution, may be any fluid capable of cleaning a mechanical part including, but not limited to, mineral spirits or the like. The parts washer system and present disclosure, however, can be used with other types of cleaning fluids such as aqueous cleaning solutions, compound solutions, or the like, and others known to those of ordinary skill in the art.

FIG. 1B illustrates an expanded view of the parts washer system of FIG. 1A. As the figure depicts, an open end of the reservoir 50 is enclosed by a removable cover 70, and a clean rinse module 80 fits in an opening in the cover 70 such that the clean rinse module 80 extends into the reservoir 50, as will be discussed in detail herein. The reservoir 50 sends contaminated fluid to the cleaning basin 20 by a pump connected to the clean rinse module 80 and receives contaminated fluid back into the reservoir 50 through an opening in the cover that is connected to a drain in cleaning basin 20. The core recycling unit 30 draws contaminated fluid from the reservoir 50, recycles the contaminated fluid into clean fluid, and transfers the clean fluid to the clean rinse module 80. The clean rinse module 80 transfers clean fluid to the cleaning basin 20 in a clean rinse mode, which is used and then returned to the reservoir 50 via the drain. The clean rinse module 80 is removably attached to the cover 70 to allow for maintenance of the parts washer assembly.

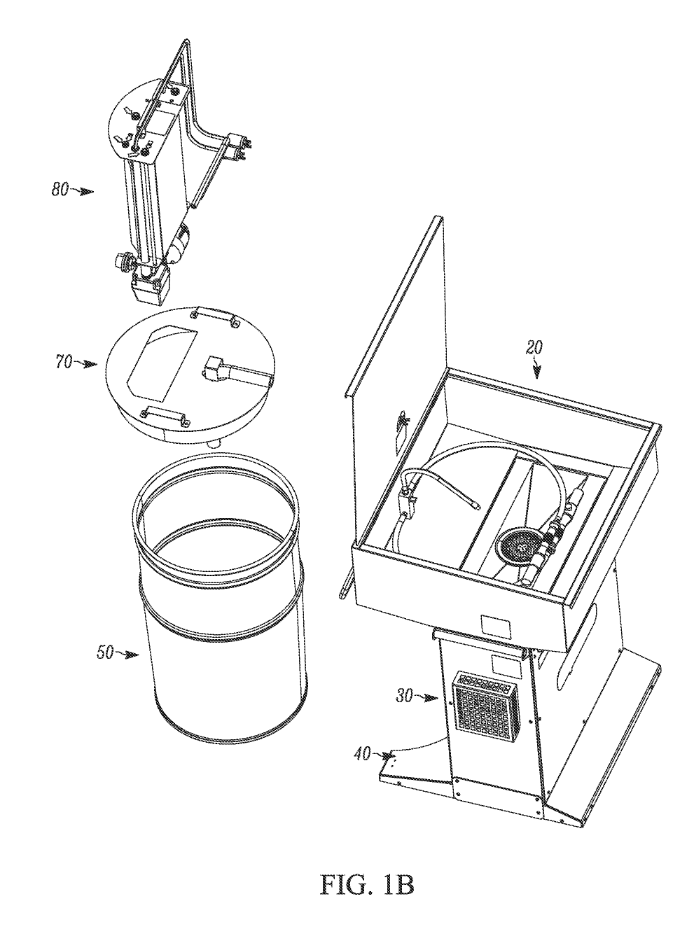

FIG. 2 illustrates a top view of the cover 70 that surmounts on an open end of the reservoir 50. The cover 70 includes an flange opening 302 and a drain line opening 304. The drain line opening 304 may be covered by a shroud 306. The cover 70 is configured to cover the entire open end of the reservoir 50. The shroud 306 may also be used as a handle to remove the cover 70 from the reservoir 50. A tube (not shown) connected to a drain in the cleaning basing passes through the opening 304 such that contaminated cleaning solution is delivered from the cleaning basin 20 to the reservoir 50. The lower portion of the cover 70 may include a ledge 308 configured to engage an open end of the reservoir 50 such that the surface of the ledge 304 is parallel with the sidewall of the reservoir 50 and a portion of the cover 70 extending beyond the ledge 308 engages a top surface of the sidewall of the reservoir 50. The cover 70 may be made from the same material as the reservoir 50 or from a different material including, but not limited to, steel, aluminum, a metal alloy, plastic, fiber glass, ceramic material, or any other rigid material capable of covering the opening in the reservoir 50.

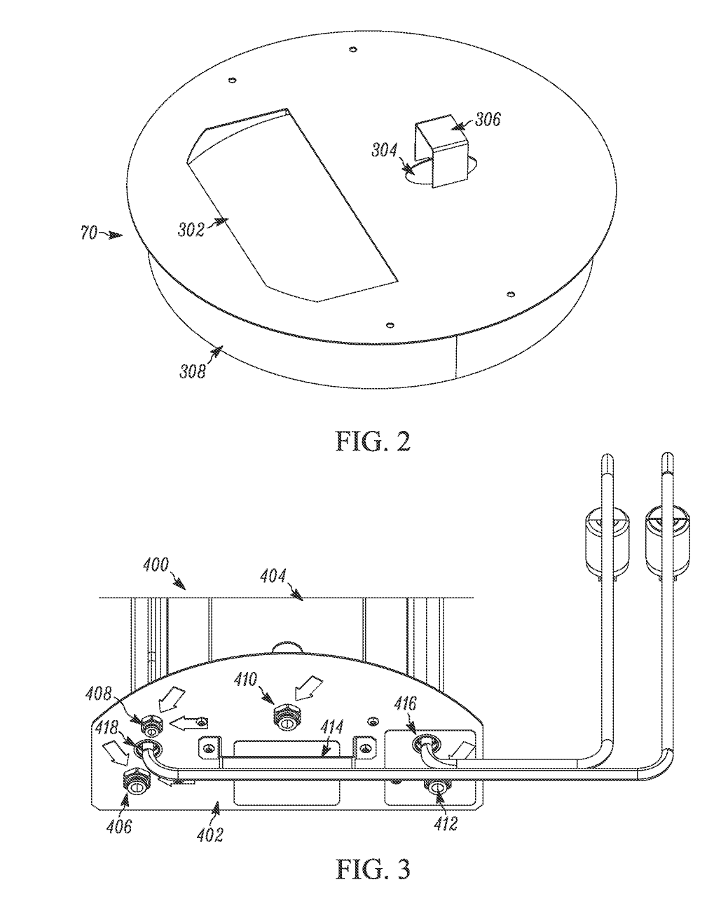

FIG. 3 illustrates a top view of the clean rinse module 80. The clean rinse module includes a flange 402 and a tank 404. The flange 402 is configured to engage the opening 302 in the cover 70 such that the flange 402 is contiguous with the cover 70 when the flange 402 engages the opening 302. A lower surface of the flange 402 is affixed to a top portion of a tank 404 such that the flange 402 encloses the tank 404. An overhanging portion of the flange 402 extends beyond each wall of the tank 404. The flange 402 may be made from the same material as the cover 70 or from a different material including, but not limited to steel, aluminum, a metal alloy, plastic, fiber glass, ceramic material, or any other rigid material capable of covering the opening in the reservoir 50.

A top surface of the flange 402 includes a first fitting 406, a second fitting 408, a third fitting 410, and a fourth fitting 412. Each fitting 406, 408, 410 and 412 extends through the flange 402 such that fluid may pass from one side of the flange 402 to an opposite side of the flange 402 through each fitting 406, 408, 410 and 412. The first fitting 406, second fitting 408 and fourth fitting 412 are each positioned on the overhang portion of the flange 402 and the third fitting 410 is positioned on a portion on the flange 402 covering the tank 404. The fittings 406, 408, 410 and 412 may be made of any solid material including plastic, rubber, polyvinyl chloride, steel, aluminum, copper, or any other material capable of conducting fluid. The portion of each fitting 406, 408, 410 and 412 outside the reservoir may be treaded.

The flange 402 includes a handle 414 affixed to the top surface of the flange 402. The handle 414 is configured to allow a user to remove the clean rinse module 80 from the reservoir 50 by applying a force to the handle 414 in a direction away from the reservoir 50. In an alternate embodiment, two handles are positioned on the top surface of the flange 402. The flange 402 also includes openings 416 and 418 formed in the overhang portion of the flange 402 on opposite sides of the handles 414. The openings 416 and 418 are sized to accommodate power wiring for two pumps positioned in the reservoir 50. The openings 416 and 418 are connected to conduits that connect the flange 402 to the pumps in the reservoir as will be discussed in detail herein. In an alternative embodiment, each opening 416 and 418 may include a gasket that creates a moisture proof barrier between the respective opening 416 and 418 and the wires extending through each opening 416 and 418.

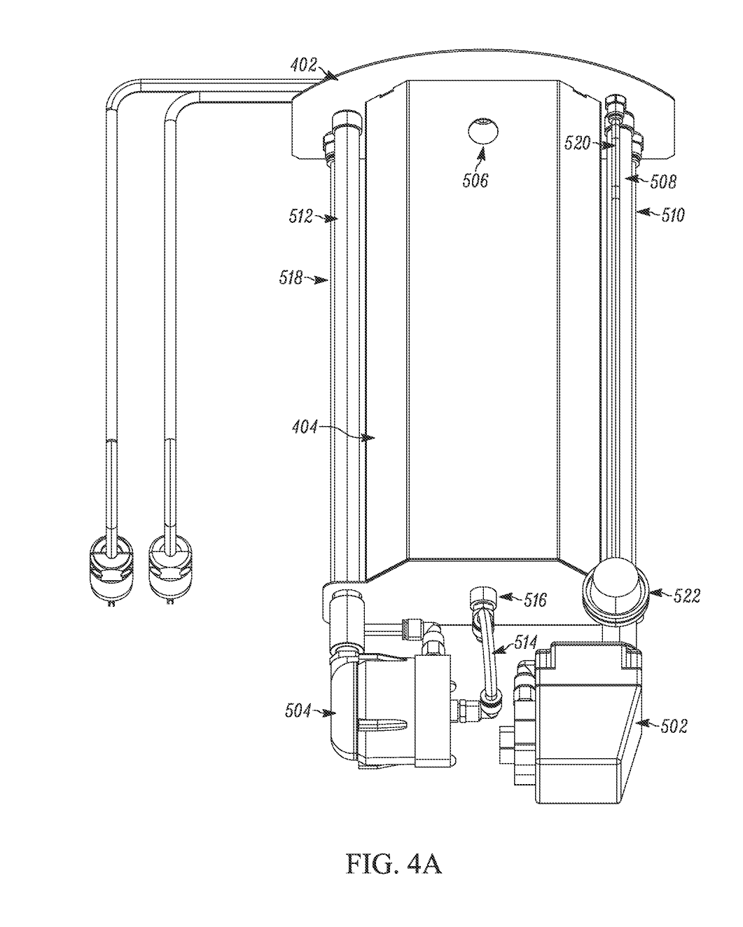

FIG. 4A illustrates a side view of the clean rinse module 80. The clean rinse module 80 includes the tank 404, the flange 402, a first pump 502, a second pump 504, and an over flow opening 506. The first pump 502 is positioned in the reservoir 50 and is secured to a lower surface of the flange 402 by a conduit 508 that is connected to the opening 418 in the flange 402. The inlet of the first pump 502 is in fluid communication with the contaminated fluid in the reservoir 50. A fluid outlet on the first pump 502 is connected to first fitting 406 on the flange 402 via a tube 510. The first pump 502 may be a centrifugal pump, screw pump, positive displacement pump, gear pump, hydraulic pump, or any other pump capable of moving fluid from the reservoir 50 through the first fitting 406. The conduit 508 may be made of a material such as, but not limited to, plastic, rubber, polyvinyl chloride, steel, aluminum, copper, or any other material capable of securing the first pump 502 to the first fitting 406. The conduit 508 is sized to engage the opening 418 and to accommodate power wiring for the first pump 502. The fluid inlet on the first pump 502 is connected to the reservoir 50 such that contaminated fluid is pulled into the first pump 502 through the fluid inlet and transferred to the first fitting 406 via the tube 510 coupled to the first fitting 406 and the fluid outlet of the first pump 502.

The second pump 504 is positioned in the reservoir 50 and is connected to a lower portion of the flange 402 by a conduit 512 that is connected to the opening 416 in the flange 402. A fluid inlet on the second pump 504 is in fluid communication with the clean fluid in the tank 404 via a tube 514 coupled to a port 516 in the bottom of the tank 404. The outlet of the second pump 504 is coupled to the forth fitting 414 via the tube 518. The second pump 504 may be a centrifugal pump, screw pump, positive displacement pump, gear pump, hydraulic pump, or any other pump capable of moving fluid from reservoir 50 through the fourth fitting 414. The conduit 512 may be made of a material such as, but not limited to, plastic, rubber, polyvinyl chloride, steel, aluminum, copper, or any other material capable of securing the second pump 504 to the flange 402. The tubes 510 and 518 may be made out of any material capable of conducting fluid including, but not limited to, plastic, rubber, polyvinyl chloride, steel, aluminum, copper, or any other material capable of conducting fluid from a pump.

A tube 520 extends downward into the reservoir 50 from the second fitting 408 on the flange 402. The end of the tube 520 may include a filter 522 secured to the end of the tube 520 to remove particulate from the contaminated fluid flowing through the tube 520. The tube 520 delivers contaminated fluid from the reservoir 50 to the core recycler component 30. A tube (not shown) extends from the third fitting 408 into the tank 404. The third fitting 408 is fluidly coupled to the outlet of the core recycling component 30 such that clean fluid is delivered to the tank 404 from the core recycling component 30. A drain (not shown) may be connected to the port 516. The drain (not shown) may be a valve that allows clean fluid to flow to the inlet of the second pump 504 or through the drain opening. The valve may be any type of valve including, but not limited to, a ball valve, a gate valve, or any other type of valve capable of preventing or allowing fluid to pass through the drain 520.

When the clean fluid in the tank 404 exceeds a high level, the overflow opening 506 in an upper portion of the tank 404 allows clean fluid to flow from the tank 404 to the reservoir 50. The overflow opening 506 is positioned a predefined distance from the bottom of the tank 404 such that the overflow opening 506 is above the level of the contaminated fluid level of the reservoir 50. In an alternate embodiment, the over flow opening 506 is a slit across an upper portion of the tank 404. In an alternate embodiment, the tank 404 includes multiple over flow openings 506. The multiple overflow openings 506 may be of different sizes and may be positioned at different distances from the bottom of the tank 404 and may also provide different flow rates through each opening 506.

FIG. 4B illustrates a side view of an alternate embodiment of the clean rinse module 80 with a side panel of the tank 404 removed for viewing purposes. Consistent with this embodiment, the second pump 504, conduit 512 and tube 518 may be positioned inside the tank 404. The fourth fitting 412 on the flange 402 is relocated to a position on the flange 402 that is directly above the tank 404 with the tube 518 connecting the second pump 504 to the fourth fitting 412 on the flange 402. In an alternate embodiment, a drain (not shown) is included in the lower portion of the tank 404. In another embodiment, the drain is omitted from the tank 404, and fluid is drained from the tank by powering the second pump 504. In another embodiment, the flange 402 is removably affixed to the tank 404 such that the flange 402 can be removed to perform maintenance on the second pump 504.

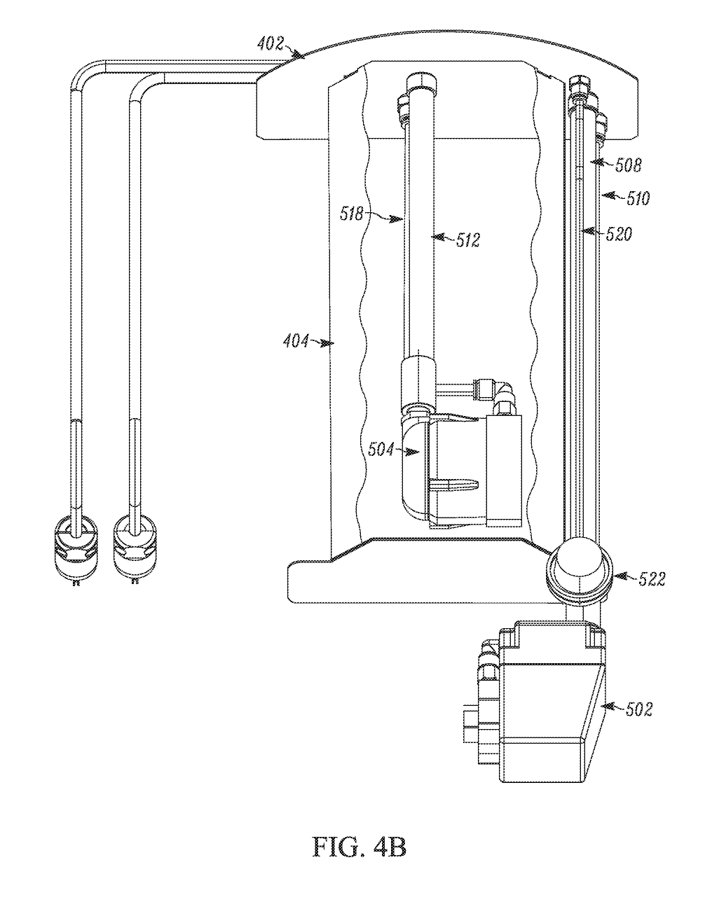

FIG. 5 illustrates a collar 600 configured to surmount to the open end of the reservoir 50. The collar 600 includes an opening 602 configured to engage the cover 70 such that the cover 70 is contiguous with the collar 600 when the cover 70 is positioned in the collar 60. In an alternative embodiment, the collar 600 includes handles 604 and 606 affixed on a top surface of the collar 600. The collar 600 may be made from the same material as the cover 70, or from a different material including, but not limited to steel, aluminum, a metal alloy, plastic, fiber glass, ceramic material, or any other rigid material capable of covering the opening in the reservoir 50.

The collar 600 is configured to allow a cover 70 of one size to operate on a reservoir 50 having an opening larger than the size of the collar 70. The collar 600 is mounted to the open end of the reservoir 50 and the cover 70 is placed into the opening 604. The opening 602 is sized such that it allows the cover 70 to fit in the opening 602 with the cover 70 being contiguous with the collar 600. By sizing the opening 602 to accommodate the cover 70, a single cover 70 may be used on different size reservoirs 50. As an illustrative example, a cover 70 sized to cover a 16 gallon drum can be used on a 30 gallon drum if a 30 gallon drum collar 60 is placed on the open end of the 30 gallon drum and the cover 70 is placed in the opening 602 in the collar 600.

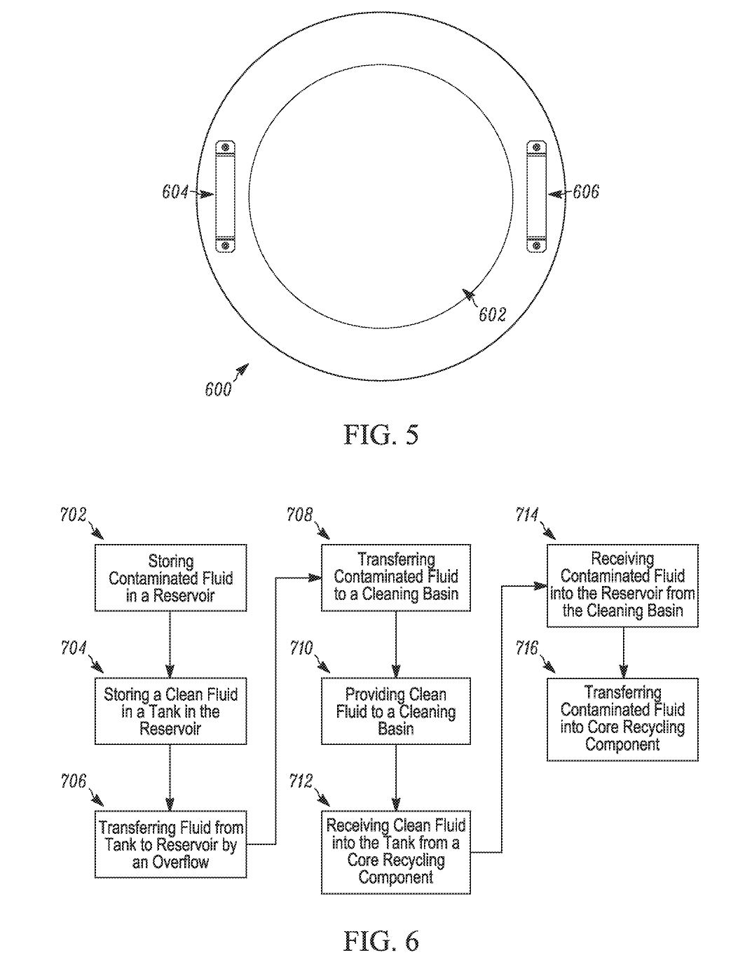

FIG. 6 illustrates a schematic representation of a process of operating the parts washer assembly of FIG. 1. In step 702, a contaminated fluid is stored in the reservoir 50. The contaminated fluid may be delivered to the reservoir 50 from the cleaning basin 20 via the drain opening 304 in the flange 402. In step 704, a clean fluid is stored in the tank 404 in the clean rinse module 80 inside the reservoir 50. In step 706, clean fluid is transferred from the tank 404 of the clean rinse module 80 to the reservoir 50 by an overflow opening 506 in the sidewall of the tank 404. The overflow opening 506 is positioned in the tank 404 such that clean fluid flows from the tank 404 to the reservoir 50 when the level of clean fluid in the tank 404 exceeds the height of the overflow opening 506.

In step 708, in a first cleaning mode, a pump 502 in the reservoir 50 transfers contaminated fluid from the reservoir 50 to the cleaning basin 20 via a tube 510 connected to first fitting 406 on the flange 402 covering an opening in the reservoir 50. In step 710, in a second clean rinse cleaning mode, a pump 504 in the tank 404 transfers clean fluid from the tank 404 in the clean rinse module 80 to the cleaning basin 20 via a tube 518 connected to the fourth fitting 412 on the flange 402.

Control of the pump 502 and the pump 504 may be by a switch (not shown) in the cleaning basin 20. A user may select the source of fluid based on the stage of cleaning or cleaning mode. As an illustrative example, the user may turn the switch to start the pump 504 to provide contaminated fluid to the cleaning basin 20 from the reservoir to rinse a part with contaminated fluid. To rinse a part with clean fluid, the user may turn the switch to the clean fluid setting which turns the pump 504 off and turns the pump 506 on. The switch may be electrically coupled to the power supply of the pumps 502 and 504 or may be connected to a control unit having a memory, a processor and an input/output module that toggles power to the pumps 504 and 506. In another embodiment, both pumps 504 and 502 are powered on when the parts washing assembly is activated. A user may select the source of the fluid delivered to the cleaning basin 20, i.e. the reservoir 50 or the clean rinse module 80, by adjusting a valve in the cleaning basin while both pumps 502 and 504 continue to operate. When one source is selected, the pump 502 or 504 associated with the unselected source continues to operate without delivering any fluid.

In step 712, the tank 404 receives clean fluid from the core recycler component 30 via a conduit or tube connected to a third fitting 410 on the flange 402. In step 714, the reservoir 50 receives contaminated fluid from the cleaning basin 20 by a tube (not shown) coupled to the drain in the cleaning basin 20 that passes through the opening 304 in the cover 70. In step 716, contaminated fluid is transferred from the reservoir 50 to the core recycler component 30 by a tube 520 connected to the second fitting 408 in the flange 402. The core recycling component may recycle the contaminated fluid using any known method of fluid recycling.

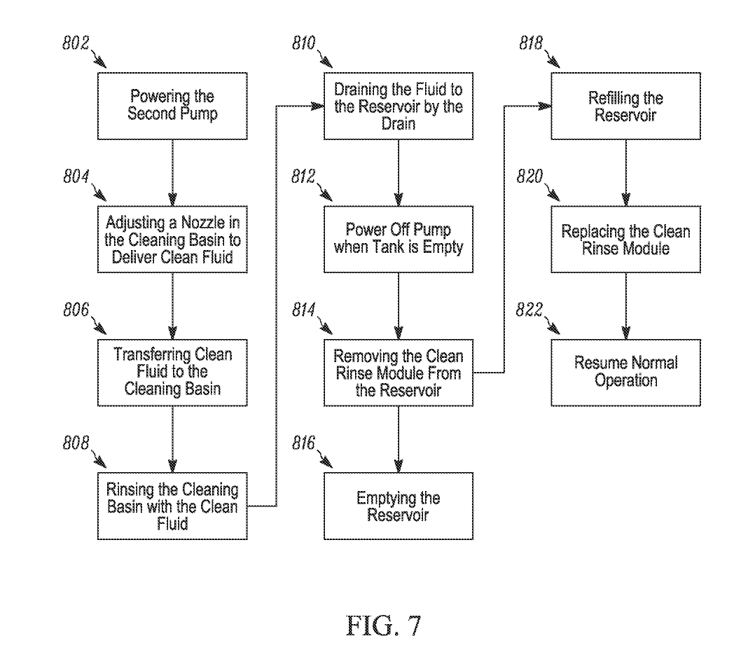

FIG. 7 illustrates a schematic representation of a maintenance process for the parts washer assembly of FIG. 1A. In step 802, the second pump 504 is powered on to provide clean fluid to the cleaning basin 20. In step 804, a nozzle in the cleaning basin 20 is adjusted such that fluid is delivered form the clean rinse module 80 to the cleaning basin 20 by the second pump 504. In step 806, clean fluid is transferred to the cleaning basin 80 from the clean rinse module 80, and a user directs the nozzle such that the cleaning basin 20 is rinsed with clean fluid. In step 810, used clean fluid is transferred from the cleaning basin 20 to the reservoir 50 via the drain opening 304 in the cover 70. In step 812, the second pump 504 continues to operate until the tank 404 in the clean rinse module 80 is empty. In an alternate embodiment, a level sensor in the tank 404 is electrically coupled to the power supply to the second pump 504 to shut off the power to the second pump 504 when the level in the tank 404 drops below a predetermined low level. In alternate embodiment, a user turns off power to the second pump 504 when clean fluid stops flowing from the nozzle in the cleaning basin 20.

In step 814, the clean rinse module 80 is removed from the cover 70 by pulling on the handle 414 on the flange 402 of the clean rinse module 80. Once removed, maintenance can be performed on the components of the clean rinse module 80. Because the fittings 406, 408, 410 and 412, pumps 504 and 506 and associated tubes and conduits are all included in the clean rinse module 80, maintenance of the components of the clean rinse module 80 is simplified. Further, because the clean rinse module 80 is full removed from the reservoir, access to each component is enhanced.

In step 816, the contaminated fluid in the reservoir is removed by draining the reservoir 50. In step 818, the reservoir is filled with clean fluid. In an alternate embodiment, the tank 404 in the clean rinse module may also be filled by the tube 518. In step 820, the clean rinse module is returned to the reservoir 50 by placing the clean rinse module 80 in the opening in the cover 70 such that the flange 402 of the clean rinse module 80 is contiguous with the cover 70. In step 822, the parts washer assembly resumes normal operation.

By providing both clean fluid and contaminated fluid to the cleaning basin 20, the system reduces the amount of fluid used to wash parts. Specifically, a user may clean a part using contaminated fluid and perform a final rinse using clean fluid to remove any attached contaminates. In addition, by allowing clean fluid to over flow from the tank 404 to the reservoir 50, the contaminated fluid is diluted with clean fluid, enhancing the process of cleaning parts with contaminated fluid. Further, since the overflow opening 304 is positioned in the tank 404 to remove excess fluid from the tank 404, a constant supply of clean fluid is available to the cleaning basin 20.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the disclosure without undue burden.

1. A parts washer assembly comprising:
a reservoir including a contaminated fluid solution at a level and having a cover surmounted on an open end of the reservoir, the cover including an opening formed therein;
a clean rinse module including a flange, a tank, a first pump and a second pump, the clean rinse module contiguous with the cover such that the flange covers the opening and the tank and the first and second pumps depend from the flange into the reservoir;
an overflow opening formed in the tank above the level of the contaminated fluid solution;
the first pump connected to the flange, and in fluid communication with the reservoir and a first fitting connected to the flange; and
the second pump connected to the flange, and in fluid communication with the tank and a second fitting connected to the flange.

2. The assembly of claim 1, wherein a collar is surmounted on the open end of the reservoir and the cover is contiguous with an opening in the collar.

3. The assembly of claim 1, wherein the first pump is secured inside the reservoir by a conduit connected the flange.

4. The assembly of claim 1, wherein the second pump is secured inside the tank by a conduit connected the flange.

5. The assembly of claim 1, wherein the first pump is in fluid communication with a cleaning basin by a first tube coupled to the first fitting on the flange, and to the tank by a second tube.

6. The assembly of claim 1, wherein the clean rinse module is removably affixed to the cover.

7. The assembly of claim 1, wherein the flange includes at least one handle on a top surface of the flange.

8. The assembly of claim 2, wherein the collar includes at least one handle on a top surface of the collar.

9. The assembly of claim 1, wherein the tank includes a drain on a lower portion of the tank.

10. A parts washer system comprising:
a reservoir including a contaminated fluid solution at a level and a cover surmounted on an open end of the reservoir, the cover including an opening formed therein;
a clean rinse module including a flange, a tank, a first pump and a second pump, the clean rinse module contiguous with the cover such that the flange covers the opening and the tank and the first and second pumps depend from the flange into the reservoir;
an overflow opening formed in the tank above the level of the contaminated fluid solution;
a cleaning basin having a drain in fluid communication with the reservoir via a first fitting connected to the flange, in fluid communication with the first pump via a tube connected to a second fitting connected to the flange, and in fluid communication with the second pump via a third fitting connected to the flange;
the second pump connected to the flange and in fluid communication with the tank by an inlet on the second pump and in fluid communication with the cleaning basin by the third fitting connected to the flange;
a parts washer unit in fluid communication with the tank via a tube coupled to a fourth fitting connected to the flange; and
the first pump connected to the flange, and in fluid communication with the reservoir by an inlet on the first pump and in fluid communication with the cleaning basin by the second fitting connected to the flange.

11. The system of claim 10, wherein a collar is surmounted on the open end of the reservoir and the cover is contiguous with an opening in the collar.

12. The system of claim 10, wherein the second pump is secured inside the tank by a conduit connected to the flange.

13. The system of claim 10, wherein the first pump is secured in the reservoir by a conduit connected to the flange.

14. The system of claim 10, wherein the clean rinse module is removably affixed to the cover.

15. The system of claim 10, wherein the flange includes at least one handle on a top surface of the flange.

16. The system of claim 10, wherein collar includes at least one handle on a top surface of the collar.

17. The system of claim 10, wherein the tank includes a drain unit on a lower portion of the tank.

18. A method of providing a clean rinse to a part disposed of in a parts washer assembly comprising:
storing a contaminated fluid solution at a level in a reservoir, the reservoir having a cover surmounted on an open end of the reservoir with the cover including an opening formed therein;
storing a clean fluid in a tank of a clean rinse module, the clean rinse module including a flange, a tank, a first pump and a second pump, the flange of the clean rinse module contiguous with the cover such that the flange covers the opening and the tank and the first and second pumps depend from the flange into the reservoir;
transferring the clean fluid from the tank to the reservoir by an overflow opening formed in the tank above the level of the contaminated fluid solution;
providing the clean fluid to the cleaning basin by the second pump, the second pump in fluid with communication with the cleaning basin by a tube connected to a second fitting on the flange;
providing contaminated fluid to the cleaning basin from the reservoir by the first pump, the first pump in fluid communication with cleaning basin by a tube connected to a first fitting on the flange;
receiving contaminated fluid from the cleaning basin by a drain on the cleaning basin, the drain in fluid communication with the reservoir by a tube an opening on the cover.

19. The method of claim 18, including the step of receiving the clean fluid from a recycling unit in fluid communication with the tank by a tube connected to a fourth fitting on the flange.

20. The method of claim 18, including the step of transferring contaminated fluid from the cleaning basin to the recycling component by a tube in fluid communication with an inlet of the recycling component.
